(19) United States
(12) Patent Application Publication
(10) Pub. No.: US 2024/0119277 A1
(43) Pub. Date: Apr. 11, 2024

(54) COMPUTER-CONTROLLED PROCESSING USING NEURAL NETWORK-BASED SELECTION OF OPTIMUM PROCESS ALGORITHM

(71) Applicant: II-VI Delaware, Inc., Wilmington, DE (US)

(72) Inventors: Eric Kallenbach, Ahrensfelde OT Eiche (DE); Patrick Kuehl, Berlin (DE)

(73) Assignee: II-VI Delaware, Inc., Wilmington, DE (US)

(21) Appl. No.: 17/960,221

(22) Filed: Oct. 5, 2022

(51) Int. Cl. G06N 3/08

(52) U.S. Cl. CPC G06N 3/08

(57) ABSTRACT

A methodology is presented for using neural network (NN) techniques to evaluate input data presented to a computer-controlled processing system. An initial evaluation is used to determine if the input data represents a valid product that is intended to be processed by one or more algorithms within the computer system. If the input data is determined to be invalid, the operation of the algorithm on the product is not initiated (or halted if previously started). Presuming a valid input is ascertained by the NN-based evaluation system, further classification and identifications may be performed to properly match the presented data with a particular system process, as well as select an optimum algorithm for preforming a given task from a set of possible algorithms that may be used for that task.

### TECHNICAL FIELD

Disclosed is a technique for applying neural network methodology to the field of computer-controlled process systems, particularly to the selection of algorithms used by such systems.

### BACKGROUND

Algorithm development is based on assumptions and constraints, where the developed algorithm is intended to be used only under these conditions. Otherwise, the application of a particular algorithm under irrelevant conditions may be pointless (or perhaps even destructive), and in most cases will cause the algorithm to fail. For example, if a computer vision algorithm is programmed to control the application of a rust-proofing overcoat to a rectangular object and the presented object (as shown by an input image) is circular, the algorithm will endeavor to find “corners”, and the result of the coating process will be unpredictable.

### SUMMARY OF THE DISCLOSURE

Disclosed is a method of using a trained neural network to recommend a particular algorithm for use by a computer vision system (or, alternatively, to “block” the use of such algorithm). The trained neural network recommends a particular algorithm for a defined task based on input data related to a workpiece. In many cases, the input data includes image data, although video data and/or unstructured data of any type may be present as well. The neural network-based recommendation may be applied a priori, or in parallel with the initiation of the computer-controlled task. In one case, the input data may be evaluated to determine if it is “valid” or “invalid” (i.e., a binary classification), where the trained neural network allows the algorithm to proceed only if valid input data is presented. In another case, the inventive system is used to perform a classification of the input data with respect to a set of possibly applicable algorithms so as to pair it with the “best fit” algorithm from the set. For example, the trained neural network may calculate the probabilities for identified branches of the network and recommend the algorithm associated with the highest overall probability.

In accordance with the disclosure as fully explained below, neural networks (perhaps trained using deep learning techniques) are employed to evaluate presented input data and determine the applicability of a possible computer algorithm to further “work” a given element (component) associated with the input data. Inasmuch as neural networks (NN) and deep learning (DL) have reached a stage where computers can “understand” (metaphorically speaking) and recognize objects with high accuracy, it is proposed to utilize a trained neural network to block further processing or recommend a particular algorithm, based on the given input data. A deep learning process may be used ab initio to create the trained neural network for the purposes of this disclosure.

An exemplary disclosed embodiment may take the form of a method of controlling selection of algorithms used by computer-controlled processing systems, where the method includes: receiving input data related to an element designated for processing under control of a computer-controlled processing system algorithm; using a trained neural network, classifying the received input data as valid or invalid, where if invalid preventing any further processing of the element, otherwise, using the trained neural network, identifying an optimal algorithm to be used for further processing of the element.

Additional embodiments allow for the trained NN-based evaluation system to match input data to one of several different types of algorithms (each algorithm for performing a different task). Further, the trained NN-based evaluation may be used to determine an initial environment/condition of the presented input data (i.e., lighting, orientation, size, etc.) and use this information to identify an optimum algorithm to be utilized by the computer-controlled processing system.

Other and further embodiments and aspects of the present disclosure will become apparent during the course of the following discussion and by reference to the accompanying drawings.

### BRIEF DESCRIPTION OF THE DRAWINGS

Referring now to the drawings, where like numerals represent like parts in several views:

FIG. 1 illustrates the problem associated with initial image data as presented to a conventional computer vision system, with FIG. 1(a) depicting a valid input data image, FIG. 1(b) showing the formation of a welded seam based on the valid input data image of FIG. 1(a), FIG. 1(c) depicting an invalid input data image, and FIG. 1(d) showing an unsuccessful attempt to process a workpiece based on the invalid image data shown in FIG. 1(c);

FIG. 2 shows the corrective nature of incorporating the disclosed NN-based evaluation methodology to the same initial image data as illustrated in FIG. 1;

FIG. 3 depicts an exemplary arrangement for using the disclosed NN-based evaluation system to properly classify input image data as related to one of a multiple number of different computer vision system algorithms;

FIG. 4 illustrates differences in lighting conditions that may be associated with two input images that are both considered as valid;

FIG. 5 depicts an alternative embodiment of the disclosed NN-based evaluation system configured to further evaluate image data as shown in FIG. 4 to assign an optimum algorithm for different conditions; and

FIG. 6 contains a flowchart describing one particular process that may be implemented by the disclosed NN-based evaluation system.

### DETAILED DESCRIPTION

In general, the algorithms used by computer-controlled processing systems change data from one form to another through a step-by-step approach. Traditional algorithms can “check” the input data for validity only up to a certain degree, and then simply execute a set of simple rules. As a result, when the input data is invalid (or corrupted), errors in the generated output data and/or unpredictable behavior of the algorithm is likely to occur.

In particular, traditional algorithms are excellent at measuring things, or calculating things, but are unaware of the validity of its input data and, as a result, may produce “false positive” outputs. While simple validity checks are possible in some situations, traditional algorithms cannot perform exhaustive checks of complex content (such as in the area of image recognition, for example).

The disclosed technique is based upon the use of a trained neural network to infer which algorithm (if any) to use based on the presented input data. The disclosed technique allows for invalid input data to be recognized (and thus block any further actions from taking place) and may also be used to classify valid input data so that the “best” algorithm from a set of algorithms related to a specific task is recommended, thus increasing the likelihood that the selected algorithm provides the optimal outcome.

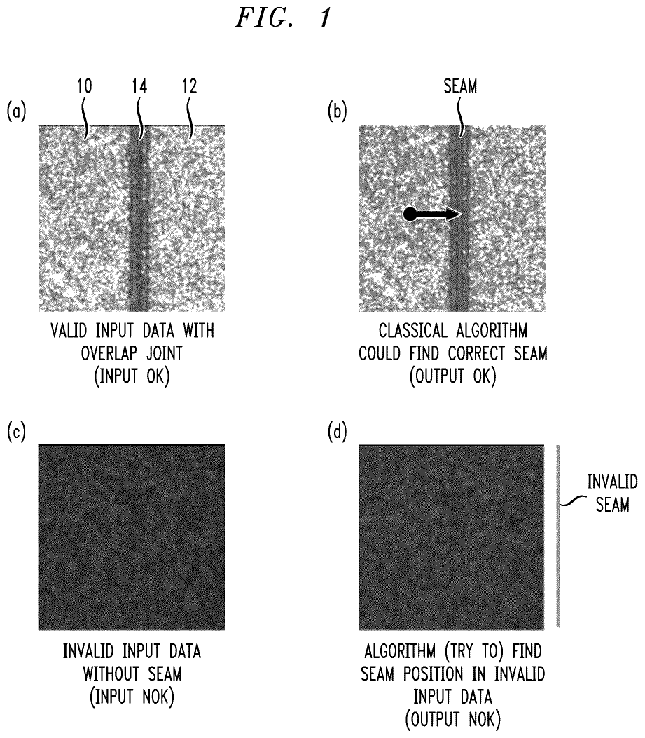

One exemplary application of the disclosed trained NN methodology may be understood with reference to FIG. 1, which is particularly directed to the utilization of a computer vision system and the use of a trained neural network to select a process algorithm for use by the vision system In particular, FIG. 1 illustrates two different initial input data images for a remote laser welding process. A computer vision system may utilize an algorithm to “find” a seam in an overlap joint between two pieces of material. FIG. 1(a) depicts a valid input data image that clearly shows a first section of material 10 and a second section of material 12, with an overlap area 14 clearly indicated. The algorithm employed by the computer vision system can then easily scan across the image and recognize a proper seam position within overlap area 14 by the change in pixel gradient, thereafter proceeding with laser welding of sections 10 and 12 along overlap seam 14, as shown in FIG. 1(b).

Alternatively, if the input data image shown is as shown in FIG. 1(c), a conventional computer vision system would allow the algorithm to scan the presented blackout image, looking for any change in gradient. That is, the conventional system has difficulty in recognizing that the input data image is invalid. The algorithm will necessarily perform to “find” anything that may be a seam, because that is its task. However, this may result in unpredictable process output as shown in FIG. 1(d), and even damage the product being worked (if the outputs are used for machine control, for example).

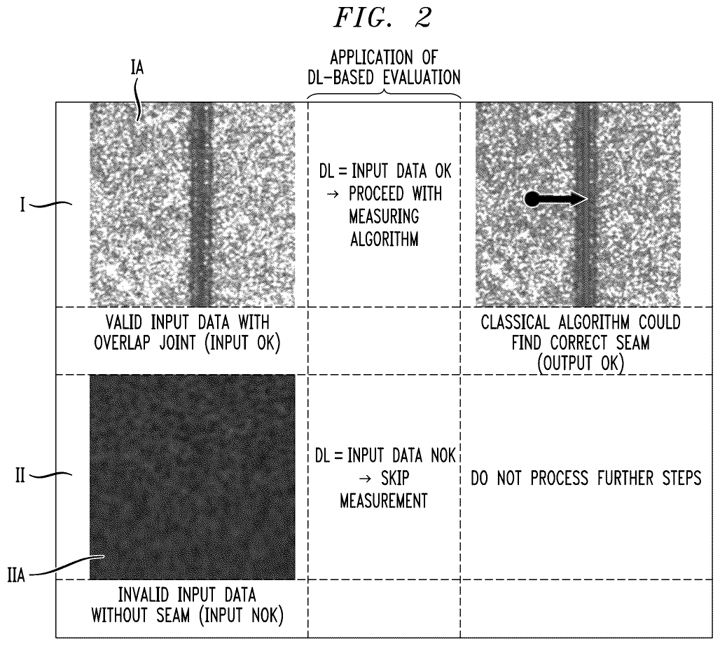

Thus, in accordance with the disclosed principles, a trained NN-based evaluation of presented input data may be performed prior to initiating a given process that is controlled by a computer-controlled processing system. In the situation as depicted in FIG. 1, the evaluation may be defined as a “binary classification”, since the input image data is evaluated to determine if it is either “valid” or “invalid”. The use of the trained NN-based methodology in this example decides whether or not the algorithm used by a computer vision-controlled remote laser welding system should proceed. FIG. 2 illustrates how this process is applied to the pair of images from FIG. 1.

Looking at FIG. 2, the left-hand portion of the illustration again includes the pair of initial input images as seen in FIG. 1. In this case, however, a trained NN-based evaluation process in accordance with the disclosed principles is first used to evaluate the image (as shown in the central portion of the illustration) prior to initiating any computer-controlled vision system algorithm. In looking at row I of FIG. 2, the presentation of image IA is evaluated, and determined to be valid (shown as “input data ok” in FIG. 2). The trained NN-based evaluation system then instructs the computer vision system to proceed with looking for the seam location, as shown in the right-hand illustration of row I.

On the other hand, when presented with the “blank” input image data of row II, the trained NN-based evaluation system will identify this image as invalid (shown in FIG. 2 as being labeled “input data NOK”, where “NOK” denotes a “not OK” finding). Thus, the trained NN-based evaluation system will not engage the computer vision system and, instead will instruct to “skip measurement”, and perhaps return an error message of “do not process further steps”.

While this example describes an instance where the NN-based classification/recommendation is performed first, it is also possible to implement the NN-based evaluation and the algorithm in parallel, requiring a “TRUE” result from each of these elements (i.e., for NN, a “TRUE” classification; for computer algorithm, a “TRUE” plausibility check) in order to proceed any further.

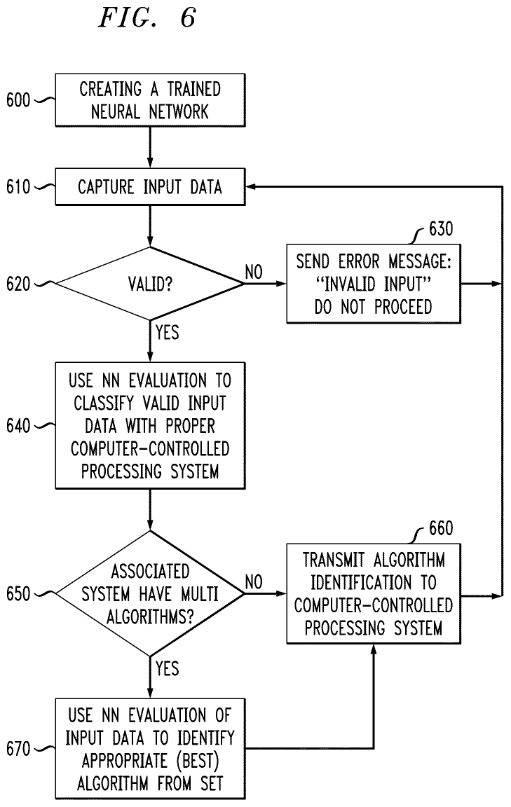

An aspect of the disclosed technique is the need to create a properly trained NN in the first instance. While many techniques are known and used to develop the various levels and interconnections within a given neural network, one approach is to apply a deep learning process, where various types of expected input data are presented and used to generate the set of elements and connections comprising the network. It is to be understood that the application of deep learning is only one possibility; the disclosed technique is more broadly directed to the utilization of a “trained” neural network to improve the efficacy of computer-controlled algorithm selection. A more complete discussion regarding the formation of a trained neural network is found below in association with the discussion of FIG. 6.

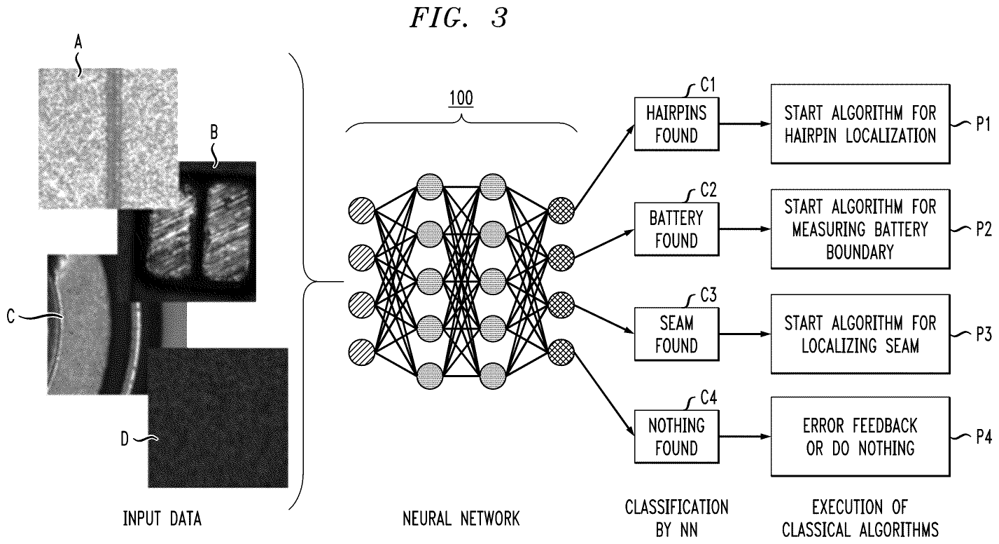

It is contemplated that in a larger context, the disclosed trained NN-based evaluation system functions not only in the binary case of recognizing valid/invalid input data, but also to classify the data as associated with a particular computer-controlled processing system from a pre-defined set of such systems. That is, the disclosed trained NN-based evaluation system may function as a classifier in a multi-class computer system environment. FIG. 3 illustrates this aspect of the disclosed NN-based evaluation system.

Prior to applying NN-based techniques to the classification of input data and selection of proper algorithms, a training period is used as mentioned above to develop a suitable interconnection of data points as the “trained” neural network. The training period may include the presentation of pre-defined data sets (e.g., images) and related detailed information, perhaps, to the system. The training/classification process is controlled and iterated until an acceptable level of recognition of the presented data sets by the NN-based system is achieved. In accordance with the disclosed principles, this means that not only is NN-based evaluation system 100 able to discern between a “valid” input and an “invalid” input, but it is also able to then associate (classify) a valid input with a particular algorithm of the computer-controlled processing system. While NN-based evaluation system 100 may be updated from time to time, such as additional training to recognize new, different input data, it is contemplated that once trained, NN-based evaluation system 100 may be utilized in a continuous manner to properly control the applicability of presented input data to one or more available algorithms.

For the purposes of describing the elements shown in FIG. 3, it is presumed that the computer-controlled processing system is a vision system that is associated with an industrial fabrication environment. In this case, computer vision algorithms are used in the performance of several different tasks (only a few of which are shown here for the sake of clarity). In this example, the remote laser welding of an overlap joint, as discussed above in association with FIGS. 1 and 2 is shown, as well as a task that looks for the ends of wires (“hairpins”) in an electric engine, and a task that searches for battery parts that need to be welded together.

FIG. 3 illustrates a set of four different input images, denoted as image A, image B, image C, and image D. Any of these images may be delivered as input data to a trained NN-based evaluation system 100 of the present disclosure, as also shown in FIG. 3. NN-based evaluation system 100 functions to process the input data through its created network, comparing it against stored information developed during training exercises and determining the best match between the input data and the type of available computer vision-controlled algorithms.

The outputs from trained NN-based evaluation system 100 are shown in FIG. 3 as classifications C1, C2, C3, and C4, where C1 is associated with “hairpin found”, C2 is associated with “battery part found”, C3 is associated with “seam found”, and C4 is associated with “invalid input” (nothing found). In addition to performing this initial classification, trained NN-based evaluation system 100 also identifies the proper algorithm (if any) to be used in the computer vision-based task associated with the defined classification. These are shown as processes P1, P2, P3, and P4 in FIG. 3, and are associated with the classifications C in a one-to-one manner. Clearly, an input that is “invalid” (such as image D in FIG. 3) will be recognized as such by trained NN-based evaluation system 100 and directed to classification C4, which will halt any further processing.

It is to be noted that trained NN-based evaluation system 100 typically does not initiate the associated algorithm; indeed, it is possible that various other tasks are performed before the use of the selected algorithm is required. Once the computer-controlled processing system is activated, however, the previous identification of the proper algorithm by the disclosed NN-based system is important to maintaining an efficient workflow.

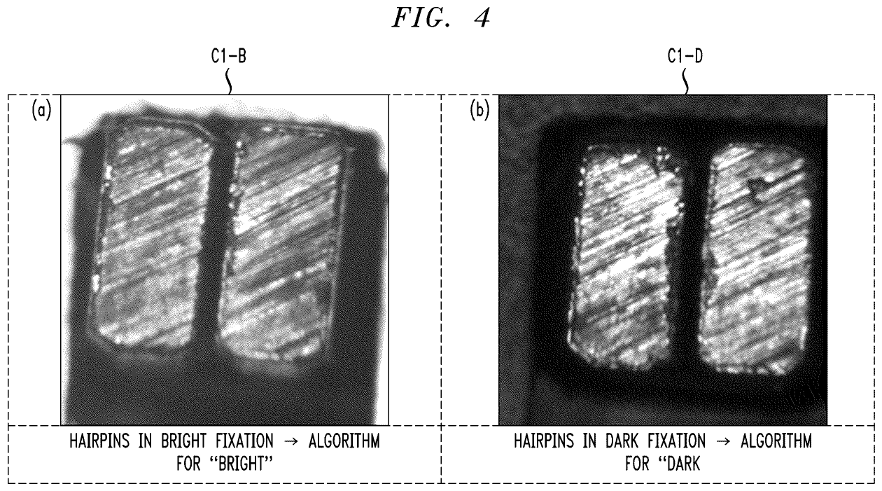

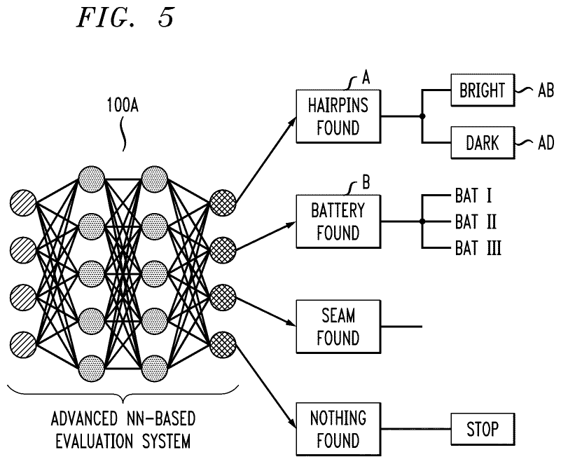

Beyond the multi-class classification capability of the disclosed trained NN-based evaluation system, it is contemplated that the same NN methodology can provide additional detail and instructions to the subsequent processing steps. This aspect of the disclosed methodology can be explained by reference to FIGS. 4 and 5, where FIG. 4 illustrates two valid, yet different, input images and FIG. 5 shows an “advanced” evaluation process 100A that may be used to direct the workpiece associated with these images to the optimum process (i.e., most appropriate algorithm). In particular, FIG. 4 illustrates two different input data images of a “hairpin” that are both considered valid. Thus, with reference back to FIG. 3, trained NN-based evaluation system 100 would classify both images as C1 (“hairpin found”), and permit the associated algorithm to initiate the associated hairpin localization process P1.

However, with reference to FIG. 4, it is evident that the background lighting environments for the two images are different, with the image shown in FIG. 4(a) being “brighter” than the image shown in FIG. 4(b). A given computer-controlled processing system may be constructed to include different algorithms for operating in different lighting conditions (or any other different type of environmental factor). Thus, as shown in FIG. 5, an advanced NN-based evaluation system 100A may be further configured (i.e. “trained” in the manner mentioned above), to select a proper algorithm from within a set of different options. While the same basic process is being controlled by the computer vision system (in this case, hairpin welding of pins), it is possible to select between a first algorithm AD used for “dark” backgrounds and a second algorithm AB used for “bright” backgrounds. Similarly, FIG. 5 shows a set of three different battery-related algorithms that may be used (perhaps dependent on the type of battery presented in the image). Again, the NN-based properties of system 100A can be used to classify the image being analyzed with the best algorithm option. These are just two examples; any other environmental facts that introduce variations to the input data image may be used for advanced NN-based evaluation system 100A to further control the process. For example, a skewed presentation of an input image may trigger a “realign” process to be initially performed. Different physical sizes of presented image elements may be used to select between a set of algorithms, and the like.

FIG. 6 contains a flowchart of an exemplary methodology that may be utilized within a trained NN-based evaluation system formed in accordance with the present disclosure. The process starts at step 600 with creating the trained neural network. The act of creating such a network is truly a “training” process, where specific sets of input data. The neural network is based on a collection of connected units (“neurons”), where the creation of a connection (“synapse”) between a pair of neurons allows for a signal to be transmitted from one to the other. Neurons may have state (generally represented by real numbers between 0 and 1). Neurons and synapses may also have a weight that varies as learning proceeds, which can increase or decrease the strength of the signal that it sends downstream. Typically, neurons are organized in layers, such as shown in FIG. 3. Signals travel from the first (input) layer to the last (output) layer possibly after traversing the layers multiple times. The neural network “learns” (i.e., progressively improves its ability) to perform tasks by considering examples, generally without task-specific programming. In the case of image recognition, exemplary image data may be manually labeled (such as “valid” or “invalid”). During a training period, additional non-labeled input data may be presented and the network's identification either affirmed or corrected. As mentioned above, the iterations of a training period continue until an acceptable level of performance is obtained.

This description of the creation of a trained NN-based evaluation system is considered to be exemplary only; those skilled in the art are adept at utilizing various techniques to create a neural network that is trained for a particular computer algorithm control/selection utilization.

Once the trained NN-based evaluation system has been created, the following steps as shown in FIG. 6 are associated with the actual utilization of the created NN-based evaluation system. In particular, an initial step 610 in its use is shown as capturing the input data. A following step, shown as decision point 620, is directed to engaging the trained NN-based evaluation system to determine whether or not the presented input data comprises “valid” data. If a “negative/false” response is generated by the NN-based evaluation system, the procedure is halted and the computer system is not engaged (or is “halted” if the process has been initiated in parallel). This is identified as step 630, where after any further processing on this invalid input data is blocked, the procedure may return to begin an evaluation process with newly-received input data.

Presuming that valid input data has been determined at decision point 620, the disclosed methodology then proceeds to step 640, which has the NN-based evaluation system proceed with classifying/assigning the input data with a proper computer-controlled procedure. The assigned procedure is further analyzed (step 650) to determine if there are multiple algorithms available for use with this procedure (such as discussed above in association with FIGS. 4 and 5). If the response is “no”, the process flow moves to step 660, where identification information for the assigned algorithm is transmitted to the computer vision-controlled process.

Alternatively, if the response at decision point 650 is “yes”, the NN-based evaluation system is used to compare properties of the input data to the available set of algorithms (step 670) and recommend a “best” algorithm to be used to further process the product, with the identification information for the recommended algorithm then transmitted to the computer vision system as before (step 660).

The process flow is contemplated as being continuous, with newly-presented input data continuing to arrive at step 610 and proceed along the various steps in the manner described above. The continuous nature is depicted in this flow chart by the arrows from steps 630 and 660 returning to the “capture input data” procedure of step 610.

It is to be understood that the disclosed methodology related to trained NN-based evaluation of input data may also be implemented in parallel with a conventional system algorithm, as compared to the serial execution examples described above. When proceeding in parallel, continued execution of the algorithm will proceed only if the results of the NN-based evaluation/classification and algorithm-based plausibility check are valid.

Moreover, the foregoing description has been presented for the purposes of illustration and description. For example, while input data is likely to comprise “image” data, it is to be understood that the trained NN-based system of this disclosure is equally well-suited for use with video data, or even unstructured input data (perhaps data related to physical aspects of a workpiece, such as its size, composition, and the like). Thus, it is not intended to be exhaustive or limit the scope of the disclosed methodology to the cited examples. Indeed, it is intended for the scope of the disclosure to be defined by the claims appended hereto, as well as their equivalents.

What is claimed is:

1. A method of controlling selection of algorithms used by computer-controlled processing systems, comprising:
receiving input data related to an element designated for processing under control of a computer-controlled processing system algorithm;
using a trained neural network, classifying the received input data as valid or invalid, where if invalid preventing any further processing of the element, otherwise,
using the trained neural network, identifying an optimal algorithm to be used for further processing of the element.

2. The method as defined in claim 1 wherein the computer-controlled processing system utilizes a plurality of different algorithms, each algorithm associated with a defined working condition, the method including the additional steps of:
if the received input data is valid, using the trained neural network to ascertain working condition data from the received input data; and
identifying an algorithm best suited for the ascertained working condition data for further processing of the element.

3. The method as defined in claim 1 wherein the computer-controlled processing system utilizes a plurality of different algorithms, each algorithm for performing a specific task on a specific product type, the method including the steps of:
if the received input data is valid, using the trained neural network to classify the received input data with respect to the specific product type; and
identifying an algorithm associated with the classified product type for use in further processing.

4. The method as defined in claim 1 wherein the computer-controlled processing system includes a plurality of different classifications of processes and at least one algorithm associated with each classification, where at least one classification further comprises individual algorithms for use with different initial states of a product, the method including the steps of:
if the trained neutral network evaluation finds the received input data to be a valid presentation of the product, performing additional NN-based evaluation to classify the received data with respect to the specific product type;
performing additional NN-based evaluation to determine if there is more than one algorithm associated with the classified process and if not, continuing with presented the element to the classified algorithm; and
if the NN-based evaluation determines the existence of multiple algorithms for the classified process, performing additional NN-based evaluation to ascertain an optimum algorithm to be used for further processing of the element.

5. The method of claim 1 wherein the computer-controlled processing systems includes at least one computer-controlled vision system.

6. The method claim 5 wherein the received input data includes image data.
